(19) United States
(12) Patent Application Publication
(10) Pub. No.: US 2019/0385215 A1
(43) Pub. Date: Dec. 19, 2019

(54) BUYER-CENTRIC MARKETPLACE USING BLOCKCHAIN

(71) Applicant: American Express Travel Related Services Company, Inc., New York, NY (US)

(72) Inventors: Andras L. Ferenczi, Peoria, AZ (US); Dallas L. Gale, Scottsdale, AZ (US); Nilesh Y. Jadhav, Phoenix, AZ (US); Harish R. Naik, Phoenix, AZ (US)

(73) Assignee: American Express Travel Related Services Company, Inc., New York, NY (US)

(21) Appl. No.: 16/012,598

(22) Filed: Jun. 19, 2018

(51) Int. Cl. G06Q 30/06; G06Q 20/38

(52) U.S. Cl. CPC G06Q 30/0633; G06Q 30/0611; G06Q 20/382

(57) ABSTRACT

A buyer-centric marketplace using blockchain is disclosed. A buyer may interact with the system to submit a buying request to a marketplace blockchain. One or more sellers may retrieve the buying request, generate seller quotes based on the buying request, and submit the seller quotes to the marketplace blockchain. One or more financial institutions may retrieve the seller quotes, generate financing products based on the seller quotes, and submit the financing products to the marketplace blockchain. The buyer can retrieve and review the seller quotes and the financing products, and select a seller quote and/or a financing product to complete the purchase.

### FIELD

This disclosure generally relates to a marketplace for purchasing goods and services, and more particularly, to systems and methods for a buyer-centric marketplace using a distributed ledger.

### BACKGROUND

A seller may offer products or services in a marketplace and buyers may interact with the marketplace to purchase the products or services from the seller. For example, typical marketplaces may comprise e-commerce or retail websites hosted by the seller, wherein the seller can post or offer a wide variety of services or products. As such, typical marketplaces may offer products or services that are not relevant to the buyer's needs. Buyers may need to navigate to additional marketplaces to search and locate relevant products or services. In response to locating a product or service meeting the buyer's needs, the buyer also does not know whether the product or service offered is the best available option for the buyer's needs, and/or whether any third-party financing options are available to be used to purchase the product or service.

### SUMMARY

A system, method, and computer readable medium (collectively, the “system”) is disclosed for a buyer-centric marketplace using blockchain. The system may include a buyer blockchain node configured to allow a buyer to retrieve and write data to a marketplace blockchain. The buyer blockchain node may write to the marketplace blockchain a buying request comprising a buyer ID, a buying category, and a buying criteria. The buyer blockchain node may retrieve from the marketplace blockchain a seller quote, wherein the seller quote is written to the marketplace blockchain by a seller blockchain node, and wherein the seller quote is based on the buying request and comprises a seller ID, the buyer ID, a quote price, and at least one of product information or service information. The buyer blockchain node may retrieve from the marketplace blockchain a financing product, wherein the financing product is written to the marketplace blockchain by a financial institution blockchain node, and wherein the financing product is based on the seller quote and comprises a financial institution ID, the seller ID, the buyer ID, and a financing offer. The buyer blockchain node may write to the marketplace blockchain a buyer order, wherein the buyer order is based on the seller quote, and wherein the buyer order comprises the buyer ID, the seller ID, buyer identifying data, and a purchase confirmation. The buyer blockchain node may write to the marketplace blockchain a financing product confirmation, wherein the financing product confirmation is based on the financing product, and wherein the financing product confirmation comprises the buyer ID, the seller ID, the financial institution ID, and a financing product acceptance.

In various embodiments, in response to the buyer blockchain node writing the financing product confirmation to the marketplace blockchain, the financial institution blockchain node may be configured to retrieve the financing product confirmation from the marketplace blockchain. A financial institution system associated with the financial institution blockchain node may be configured to transmit a payment to a seller system associated with the seller blockchain node. In response to the buyer blockchain node writing the buyer order to the marketplace blockchain and in response to receiving the payment from the financial institution system, the seller system may be configured to retrieve the buyer order from the marketplace blockchain and complete the buyer order.

In various embodiments, the seller quote may be written to the marketplace blockchain in response to the seller blockchain node receiving a buying request notification from a seller blockchain oracle, retrieving the buying request from the marketplace blockchain, and receiving the seller quote from the seller system. The financing product may be written to the marketplace blockchain in response to the financial institution blockchain node receiving a seller quote notification from a financial institution blockchain oracle, retrieving the seller quote from the marketplace blockchain, and receiving the financing product from the financial institution system. The buyer order may be written to the marketplace blockchain in response to the buyer blockchain node receiving a second seller quote notification from a buyer blockchain oracle, retrieving the seller quote from the marketplace blockchain, and receiving the buyer order from a buyer system associated with the buyer blockchain node. The financing product confirmation may be written to the marketplace blockchain in response to the buyer blockchain node receiving a financing product notification from the buyer blockchain oracle, retrieving the financing product from the marketplace blockchain, and receiving the financing product confirmation from the buyer system.

In various embodiments, the buying request, the seller quote, the financing product, the buyer order, the financing product confirmation, and the payment may each comprise a transaction ID.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

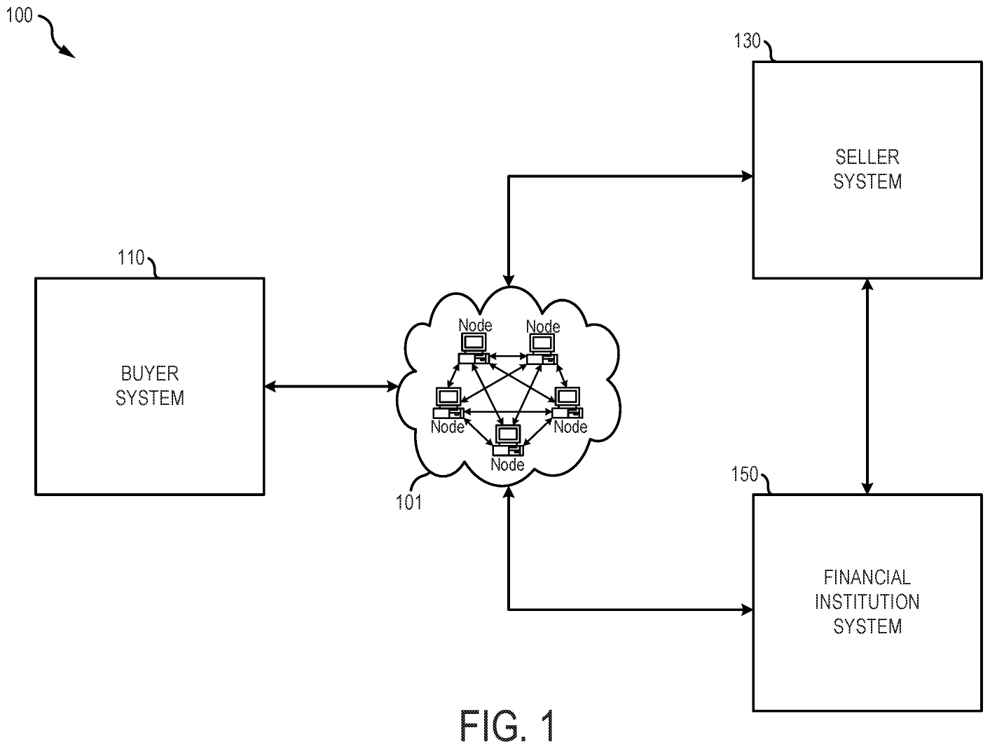

FIG. 1 is a block diagram illustrating a buyer-centric marketplace system, in accordance with various embodiments;

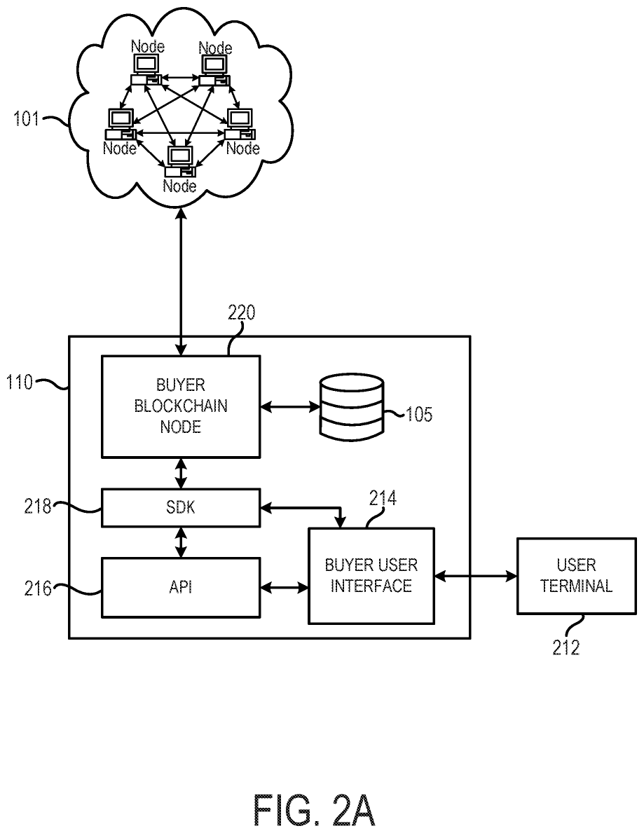

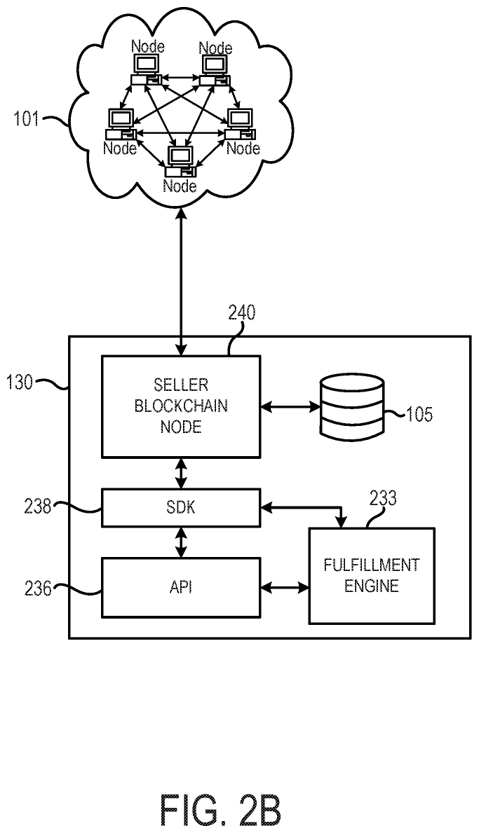

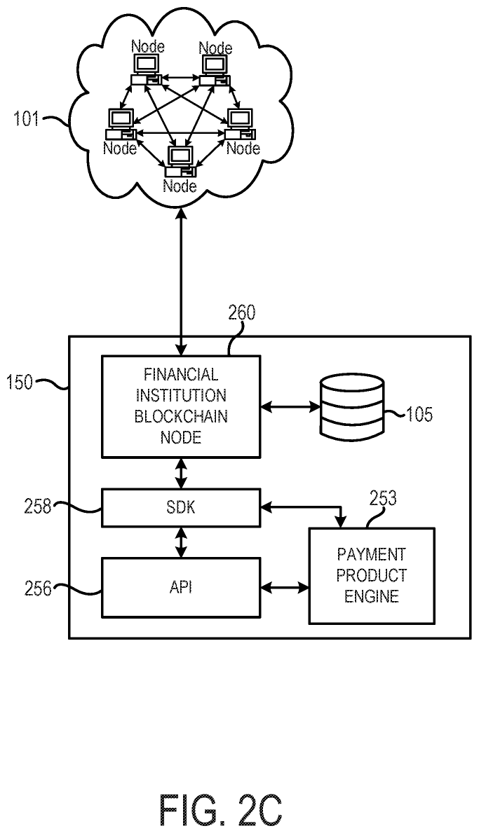

FIG. 2A is a block diagram illustrating an exemplary buyer system in the buyer-centric marketplace system, in accordance with various embodiments;

FIG. 2B is a block diagram illustrating an exemplary seller system in the buyer-centric marketplace system, in accordance with various embodiments;

FIG. 2C is a block diagram illustrating an exemplary financial institution system in the buyer-centric marketplace system, in accordance with various embodiments;

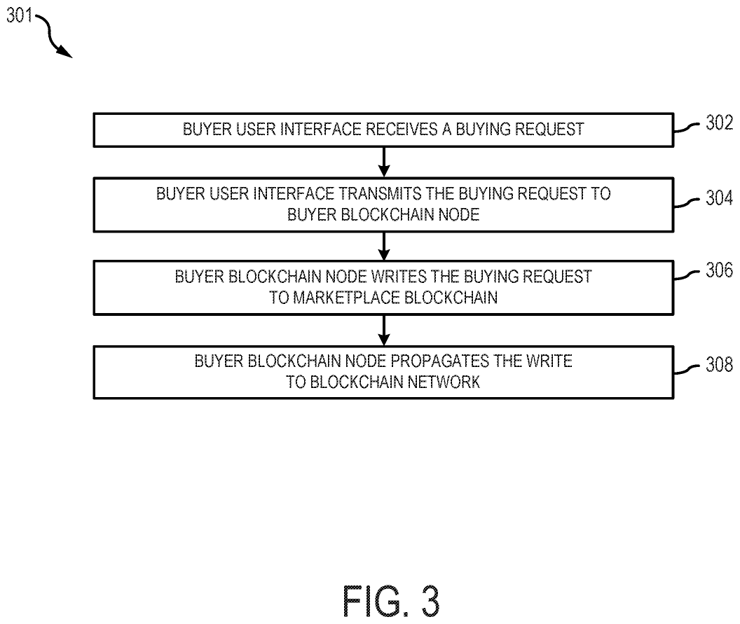

FIG. 3 illustrates a process flow for initiating a buying request in the buyer-centric marketplace system, in accordance with various embodiments;

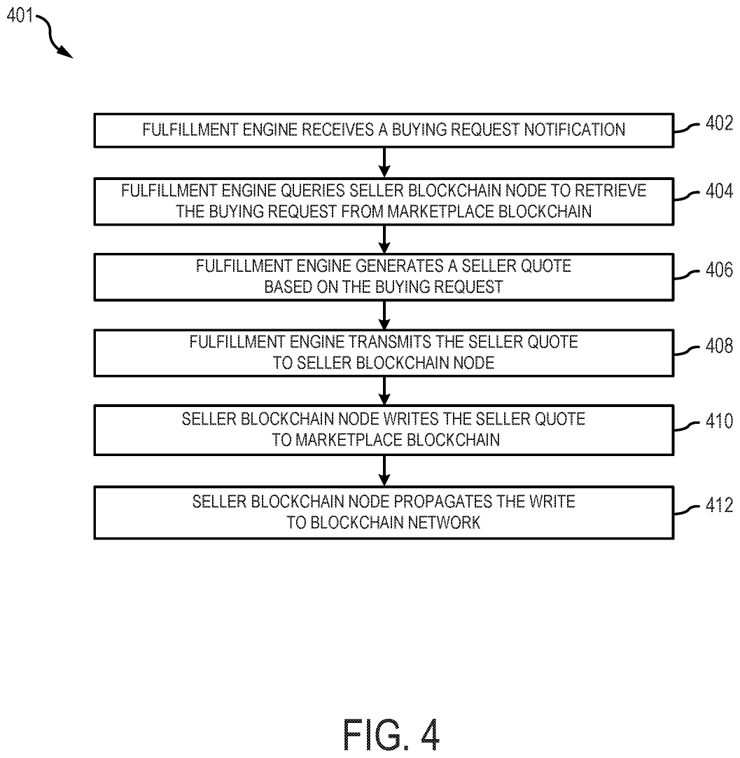

FIG. 4 illustrates a process flow for generating a seller quote based on the buying request in the buyer-centric marketplace system, in accordance with various embodiments;

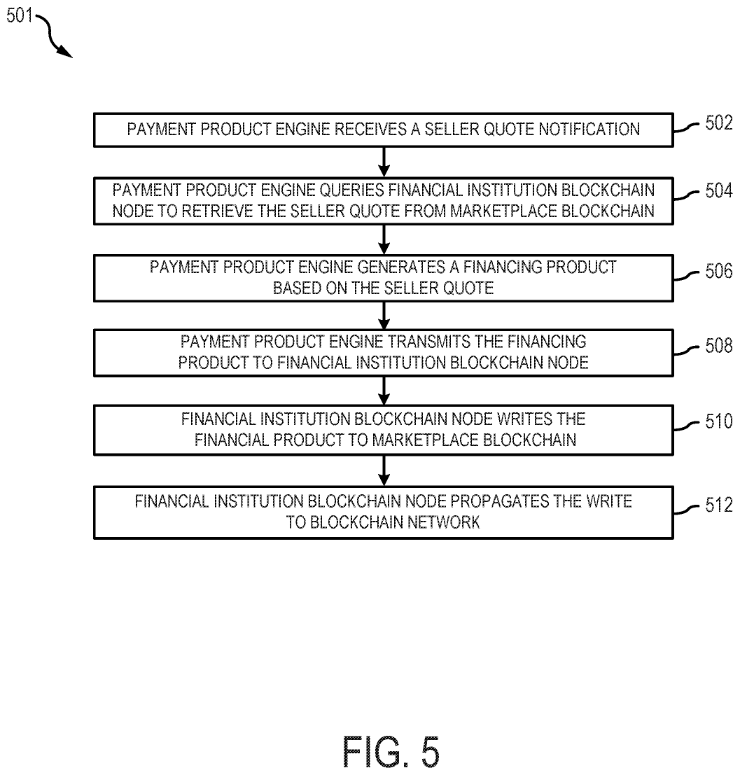

FIG. 5 illustrates a process flow for generating a financing product based on the seller quote in the buyer-centric marketplace system, in accordance with various embodiments; and

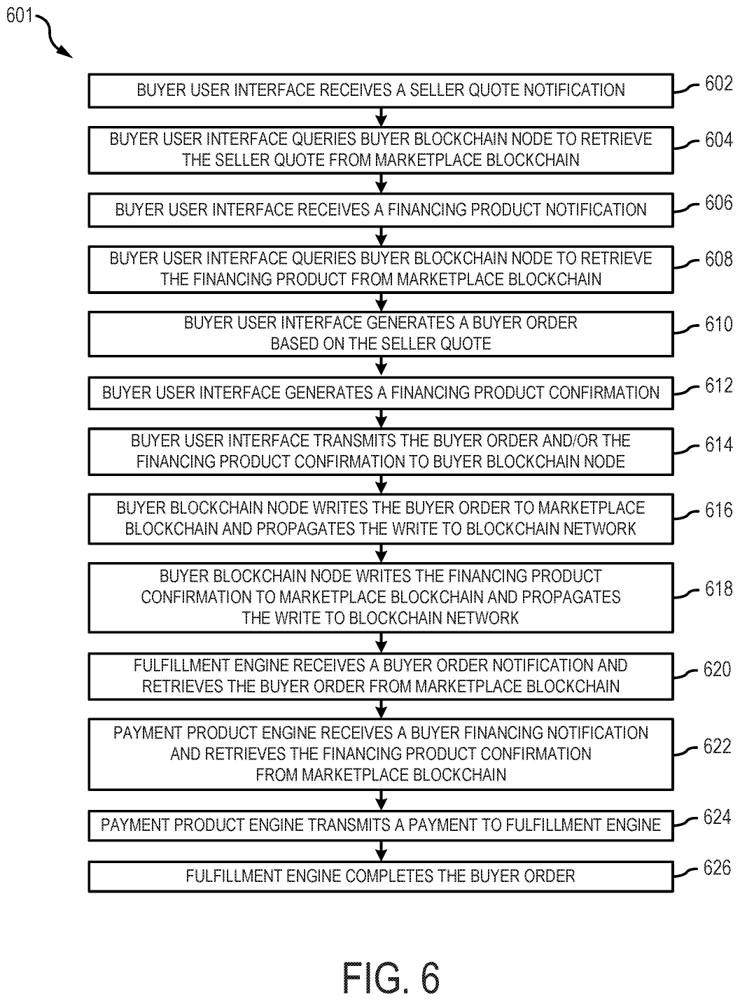

FIG. 6 illustrates a process flow for completing a buyer order in the buyer-centric marketplace system, in accordance with various embodiments.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized and that logical and physical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The buyer-centric marketplace system may be used to facilitate buyer-initiated transactions between the buyer and a seller using a blockchain. The buyer-centric marketplace system may also connect the buyer to one or more financial institutions offering financing products to complete the purchase with the seller. For example, a buyer may post to the blockchain a buying request comprising a service, product, or the like that the buyer desires to purchase. One or more sellers may retrieve the buying request from the blockchain and post to the blockchain a seller quote comprising each seller's offer to fulfill the buying request. One or more financial institutions may retrieve each seller quote from the blockchain and post to the blockchain a financing product offer for the buyer to complete the purchase. In that respect, the buyer may have several competitive buying options and financing products from which to select. The buyer may retrieve and select a seller quote and/or a financing product, and may post a buyer order and a financing product notification to the blockchain to complete the purchase. The buyer-centric marketplace system may also allow the various parties to provide feedback on the other parties via a reputation ledger or the like. The buyer-centric marketplace system may use smart contracts to enforce the data workflows and rules, and to establish trust between the parties.

The systems, methods, and computer readable mediums (collectively, the “system”) described herein, in accordance with various embodiments, may use a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers (e.g., buying requests, seller quotes, financing products, buyer orders, financing product confirmations, etc.) performed through the system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times and the speed of transferring data, initiating purchases, and completing purchases in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of buying requests and purchases by performing cryptographic processes on data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. Further, by syncing data with the involved parties in real time (or near real time), the system may improve data integrity, data confidentiality, and data security, which may also improve the speed of the business process. The system also offers increased reliability and fault tolerance over traditional databases (e.g., relational databases, distributed databases, etc.) as each node may operate with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, and U.S. application Ser. No. 15/824,513 titled TRANSACTION AUTHORIZATION PROCESS USING BLOCKCHAIN and filed on Nov. 28, 2017, the contents of which are each incorporated by reference in its entirety.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

With reference to FIG. 1, a buyer-centric marketplace system 100 is depicted according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing. System 100 based on a blockchain, as described herein, may simplify and automate reward points transfers and related processes by using the blockchain as a distributed and tamper-proof data store. Transparency is very high for various embodiments using a federated or public blockchain since validation is performed, for example, using data stored by a decentralized autonomous organization (DAO) instead of a specific financial institution.

In various embodiments, system 100 may comprise a buyer system 110, a seller system 130, a financial institution system 150, and/or a blockchain network 101. Blockchain network 101 may be in electronic communication with buyer system 110, seller system 130, and/or financial institution system 150, via one or more blockchain nodes, as discussed further herein. Blockchain network 101 may be a blockchain network or peer-to-peer network that is private, consortium and/or public in nature (e.g., ETHEREUM®, Bitcoin, HYPERLEDGER® Fabric, etc.). Consortium and private networks may offer improved control over the content of the blockchain and public networks may leverage the cumulative computing power of the network to improve security. The blockchain network 101 may comprise various transfer blockchain nodes in electronic communication with each other, as discussed further herein.

In various embodiments, buyer system 110 may enable a buyer to interact with system 100 to submit a buying request, view seller quotes and financing products, complete purchases, and/or the like. Buyer system 110 may comprise any suitable combination of hardware, software, and/or database components. For example, buyer system 110 may comprise at least one computing device in the form of a computer or processor, or a set of computers/processors, although other types of computing units or systems may be used, such as, for example, a server, web server, pooled servers, or the like. Buyer system 110 may also include one or more data centers, cloud storages, or the like, and may include software, such as APIs, configured to retrieve and write data to the blockchain. In various embodiments, buyer system 110 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

Although the present disclosure makes reference to buyer system 110, it should be understood that principles of the present disclosure may be applied to a buyer-centric marketplace system having any suitable number of buyer systems interconnected to blockchain network 101.

In various embodiments, and with reference to FIG. 2A, an exemplary buyer system 110 is depicted. Buyer system 110 may comprise one or more of a user terminal 212, a buyer user interface 214, an application programming interface (API) 216, a software development kit (SDK) 218, and/or a buyer blockchain node 220 configured to maintain marketplace blockchain 105. User terminal 212, buyer user interface 214, API 216, SDK 218, and/or buyer blockchain node 220 may be in direct logical communication with each other via a bus, network, and/or through any other suitable means, or may be individually connected as described further herein.

In various embodiments, user terminal 212 may be configured to provide a buyer, user, or the like access to buyer system 110. For example, the buyer may interact with buyer system 110, via user terminal 212, to input and submit buying requests, review seller quotes and/or financing products, and input buyer orders and/or financing product confirmations, as discussed further herein. User terminal 212 may be in electronic communication with buyer user interface 214, and may comprise any suitable hardware, software, and/or database components capable of sending, receiving, and storing data. For example, user terminal 212 may comprise a personal computer, personal digital assistant, cellular phone, smartphone (e.g., IPHONE®, BLACKBERRY®, and/or the like), Internet of things (IoT) device, kiosk, and/or the like. User terminal 212 may comprise an operating system, such as, for example, a WINDOWS® mobile operating system, an ANDROID® operating system, APPLE® IOS®, a BLACKBERRY® operating system, and the like. User terminal 212 may comprise software components installed on user terminal 212 and configured to allow a user, via user terminal 212, access to buyer user interface 214 in buyer system 110. For example, user terminal 212 may comprise a web browser (e.g., MICROSOFT INTERNET EXPLORER®, GOOGLE CHROME®, etc.), an application, a micro-app or mobile application, or the like, configured to allow a user to access and interact with buyer user interface 214.

In various embodiments, buyer user interface 214 may be accessible via user terminal 212. Buyer user interface 214 may comprise software, a web page, or the like, and may be accessible via a web browser (e.g., GOOGLE CHROME®, MICROSOFT INTERNET EXPLORER®, etc.), a mobile application (e.g., downloaded via APPLE® APP STORE®, GOOGLE PLAY®, etc.), or the like on user terminal 212. In that regard, the buyer, via user terminal 212, may access buyer user interface 214 to register for the marketplace, submit buying requests, view seller quotes and/or financing products, and submit buyer orders and/or financing product confirmations to complete purchases. In various embodiments, buyer user interface 214 may be in electronic communication with buyer blockchain node 220 via API 216 and/or SDK 218.

In various embodiments, API 216 and SDK 218 may be configured to provide software, services, and interfaces to enable communications between buyer user interface 214 and buyer blockchain node 220. API 216 and SDK 218 may comprise programmatic libraries configured to translate and transmit queries and commands from buyer user interface 214 to buyer blockchain node 220. For example, and in accordance with various embodiments, API 216 and/or SDK 218 may be configured to translate requests received by buyer user interface 214 into a blockchain format using a blockchain SDK library, or the like, which may include digital signing using buyer-specific security certificates. In that respect, API 216 and/or SDK 218 may comprise one or more buyer-specific cryptographic keys used to perform cryptographic operations. As a further example, and in accordance with various embodiments, API 216 and/or SDK 218 may be configured to translate data retrieved from marketplace blockchain 105 into a format readable by buyer user interface 214, which may include digital signature verification and/or data transformation from a blockchain specific data layout to an application specific data layout. As an example, SDK 218 may include a blockchain oracle configured to generate one or more notifications in response to data being written to marketplace blockchain 105. The blockchain oracle may be configured to query buyer blockchain node 220 at a defined interval to search for new writes to marketplace blockchain 105. The blockchain oracle may be controlled by notification triggers containing filters indicating the types of data written to marketplace blockchain 105 that will generate a notification. For example, in response to the blockchain oracle determining that data has been written to marketplace blockchain 105 that includes the buyer ID, a seller ID, and data indicating a seller's response to a buying request (e.g., a seller quote was written to marketplace blockchain 105), the blockchain oracle may generate a seller quote notification and transmit the seller quote notification to buyer user interface 214. As a further example, in response to the blockchain oracle determining that data has been written to marketplace blockchain 105 that includes the buyer ID, a financial institution ID, and data indicating a financing product corresponding to the seller quote (e.g., a financing product was written to marketplace blockchain 105), the blockchain oracle may generate a financing product notification and transmit the financing product notification to buyer user interface 214.

In various embodiments, buyer blockchain node 220 may be in electronic communication with blockchain network 101, and may be configured to allow buyer system 110 access to marketplace blockchain 105 and blockchain network 101. Buyer blockchain node 220 may be configured to maintain a copy of marketplace blockchain 105, write and/or retrieve data and blocks from marketplace blockchain 105, validate blocks of marketplace blockchain 105, and/or propagate writes to marketplace blockchain 105 to blockchain network 101. Buyer blockchain node 220 may communicate with one or more blockchain nodes (e.g., seller blockchain node 240, financial institution blockchain node 260, etc.) to validate and write blocks to marketplace blockchain 105, and to establish consensus between the blockchain nodes based on proof of work, proof of stake, practical byzantine fault tolerance, delegated proof of stake, or other suitable consensus algorithms.

Buyer blockchain node 220 may comprise one or more computing devices, such as, for example a computer or processor, or a set of computers, processor, and/or application specific integrated circuits (ASICs), although other types of computing units or system may also be used. Exemplary computing devices may include servers, pooled servers, laptops, notebooks, hand held computers, personal digital assistants, cellular phones, smart phones (e.g., IPHONE®, BLACKBERRY®, ANDROID®, etc.), tablets, wearables (e.g., smart watches, smart glasses, etc.), Internet of things (IoT) devices, or any other device capable of receiving data over a network. Buyer blockchain node 220 may run applications to interact with marketplace blockchain 105, communicate with other devices, perform crypto operations, and otherwise operate within buyer system 110. For example, buyer blockchain node 220 may run a client application that can be a thin client (web), a hybrid (i.e., web and native, such as iOS and Android), or a native application to make application programming interface (API) calls to interact with marketplace blockchain 105, such as a web3 API compatible with blockchain databases maintained by ETHEREUM®.

In various embodiments, marketplace blockchain 105 may be a distributed ledger that maintains records in a readable manner and that is resistant to tampering. Marketplace blockchain 105 may be based on blockchain technologies such as, for example, ETHEREUM®, Open Chain, Chain Open Standard, HYPERLEDGER® Fabric, CORDA CONNECT®, INTEL® Sawtooth, etc. Marketplace blockchain 105 may comprise a ledger of interconnected blocks containing data. Each block may link to the previous block and may include a timestamp. Each block may hold one or more of buying requests, seller quotes, financing products, buyer orders, financing product confirmations, payments, or the like. When implemented in support of system 100, marketplace blockchain 105 may serve as an immutable log of transaction in system 100. Marketplace blockchain 105 may be maintained on various transfer blockchain nodes (e.g., buyer blockchain node 220, seller blockchain node 240, financial institution blockchain node 260, etc.) in the form of copies or partial copies of the marketplace blockchain, as discussed further herein. Blocks (e.g., including buying requests, seller quotes, financing products, buyer orders, financing product confirmations, payments, etc.) may be written to marketplace blockchain 105 by establishing consensus between the blockchain nodes based on proof of work, proof of stake, practical byzantine fault tolerance, delegated proof of stake, or other suitable consensus algorithms.

With reference again to FIG. 1, seller system 130 may enable a seller to interact with system 100 to retrieve and view buying requests, submit seller quotes, complete buyer orders, and/or the like. Seller system 130 may comprise any suitable combination of hardware, software, and/or database components. For example, seller system 130 may comprise at least one computing device in the form of a computer or processor, or a set of computers/processors, although other types of computing units or systems may be used, such as, for example, a server, web server, pooled servers, or the like. Seller system 130 may also include one or more data centers, cloud storages, or the like, and may include software, such as APIs, configured to retrieve and write data to the blockchain. In various embodiments, seller system 130 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein. Seller system 130 may also comprise any suitable number of back-end systems to provide item inventory, transaction processing, item shipment and/or delivery, and/or the like.

Although the present disclosure makes reference to seller system 130, it should be understood that principles of the present disclosure may be applied to a buyer-centric marketplace system having any suitable number of seller systems interconnected to blockchain network 101.

In various embodiments, and with reference to FIG. 2B, an exemplary seller system 130 is depicted. Seller system 130 may comprise one or more of a fulfillment engine 233, an application programming interface (API) 236, a software development kit (SDK) 238, and/or a seller blockchain node 240 configured to maintain marketplace blockchain 105. Fulfillment engine 233, API 236, SDK 238, and/or a seller blockchain node 240 may be in direct logical communication with each other via a bus, network, and/or through any other suitable means, or may be individually connected as described further herein.

In various embodiments, fulfillment engine 233 may be configured to retrieve buying requests from marketplace blockchain 105, via seller blockchain node 240, generate one or more seller quotes based on the buying request, and transmit the seller quotes to marketplace blockchain 105, via seller blockchain node 240, as discussed further herein. In response to the buyer accepting a seller quote and writing a buyer order to marketplace blockchain 105, fulfillment engine 233 may be configured to complete the purchase, as discussed further herein. Fulfillment engine 233 may be in electronic and/or operative communication with back-end systems of seller system 130, such as, for example, systems configured to provide product inventory, transaction processing, item shipment and/or delivery, and/or the like. Fulfillment engine 233 may also be in electronic communication with seller blockchain node 240, via API 236 and/or SDK 238.

In various embodiments, API 236 and SDK 238 may be configured to provide software, services, and interfaces to enable communications between fulfillment engine 233 and seller blockchain node 240. API 236 and SDK 238 may comprise programmatic libraries configured to translate and transmit queries and commands from fulfillment engine 233 to seller blockchain node 240. For example, and in accordance with various embodiments, API 236 and/or SDK 238 may be configured to translate data received from fulfillment engine 233 into a blockchain format using a blockchain SDK library, or the like, which may include digital signing using seller-specific security certificates. In that respect, API 236 and/or SDK 238 may comprise one or more seller-specific cryptographic keys used to perform cryptographic operations. As a further example, and in accordance with various embodiments, API 236 and/or SDK 238 may be configured to translate data retrieved from marketplace blockchain 105 into a format readable by fulfillment engine 233, which may include digital signature verification and/or data transformation from a blockchain specific data layout to an application specific data layout.

As an example, SDK 238 may include a blockchain oracle configured to generate one or more notifications in response to data being written to marketplace blockchain 105. The blockchain oracle may be configured to query seller blockchain node 240 at a defined interval to search for new writes to marketplace blockchain 105. The blockchain oracle may be controlled by notification triggers containing filters indicating the types of data written to marketplace blockchain 105 that will generate a notification. For example, in response to the blockchain oracle determining that data has been written to marketplace blockchain 105 that includes the buyer ID and data indicating a desired buying request (e.g., a buying request was written to marketplace blockchain 105), the blockchain oracle may generate a buying request notification and transmit the buying request notification to fulfillment engine 233. As a further example, in response to the blockchain oracle determining that data has been written to marketplace blockchain 105 that includes the buyer ID and the seller ID and data indicating the acceptance of a seller quote (e.g., a buyer order was written to marketplace blockchain 105), the blockchain oracle may generate a buyer order notification and transmit the buyer order notification to fulfillment engine 233.

In various embodiments, seller blockchain node 240 may be in electronic communication with blockchain network 101, and may be configured to allow seller system 130 access to marketplace blockchain 105 and blockchain network 101. Seller blockchain node 240 may be configured to maintain a copy of marketplace blockchain 105, write and/or retrieve data and blocks from marketplace blockchain 105, validate blocks of marketplace blockchain 105, and/or propagate writes to marketplace blockchain 105 to blockchain network 101. Seller blockchain node 240 may communicate with one or more blockchain nodes (e.g., buyer blockchain node 220, financial institution blockchain node 260, etc.) to validate and write blocks to marketplace blockchain 105, and to establish consensus between the blockchain nodes based on proof of work, proof of stake, practical byzantine fault tolerance, delegated proof of stake, or other suitable consensus algorithms.

Seller blockchain node 240 may comprise one or more computing devices, such as, for example a computer or processor, or a set of computers, processor, and/or application specific integrated circuits (ASICs), although other types of computing units or system may also be used. Exemplary computing devices may include servers, pooled servers, laptops, notebooks, hand held computers, personal digital assistants, cellular phones, smart phones (e.g., IPHONE®, BLACKBERRY®, ANDROID®, etc.), tablets, wearables (e.g., smart watches, smart glasses, etc.), Internet of things (IoT) devices, or any other device capable of receiving data over a network. Seller blockchain node 240 may run applications to interact with marketplace blockchain 105, communicate with other devices, perform crypto operations, and otherwise operate within seller system 130. For example, seller blockchain node 240 may run a client application that can be a thin client (web), a hybrid (i.e., web and native, such as iOS and Android), or a native application to make application programming interface (API) calls to interact with marketplace blockchain 105, such as a web3 API compatible with blockchain databases maintained by ETHEREUM®.

With reference again to FIG. 1, financial institution system 150 may interact with system 100 to retrieve and view buying requests and/or seller quotes, submit financing products, transmit payments to complete buyer orders, and/or the like. Financial institution system 150 may comprise any suitable combination of hardware, software, and/or database components. For example, may comprise one or more network environments, servers, computer-based systems, processors, databases, and/or the like. Financial institution system 150 may comprise at least one computing device in the form of a computer or processor, or a set of computers/processors, although other types of computing units or systems may be used, such as, for example, a server, web server, pooled servers, or the like. Financial institution system 150 may also include one or more data centers, cloud storages, or the like, and may include software, such as APIs, configured to retrieve and write data to the blockchain. In various embodiments, financial institution system 150 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, financial institution system 150 may comprise or interact with a traditional payment network to facilitate purchases and payments, authorize transactions, and/or settle transactions. For example, financial institution system 150 may represent existing proprietary networks that presently accommodate transactions for credit cards, debit cards, and/or other types of transaction accounts or transaction instruments. Financial institution system 150 may be a closed network that is secure from eavesdroppers. In various embodiments, financial institution system 150 may comprise an exemplary transaction network such as AMERICAN EXPRESS®, VISANET®, MASTERCARD®, DISCOVER®, INTERAC®, Cartes Bancaires, JCB®, private networks (e.g., department store networks), and/or any other payment network. Financial institution system 150 may include systems and databases related to financial and/or transactional systems and processes, such as, for example, one or more authorization engines, authentication engines and databases, settlement engines and databases, accounts receivable systems and databases, accounts payable systems and databases, and/or the like. For example, financial institution system 150 may authorize and settle payment transactions, and maintain transaction account member databases, accounts receivable databases, accounts payable databases, or the like.

Although the present disclosure makes reference to financial institution system 150, it should be understood that principles of the present disclosure may be applied to a buyer-centric marketplace system having any suitable number of financial institution systems interconnected to blockchain network 101.

In various embodiments, and with reference to FIG. 2C, an exemplary financial institution system 150 is depicted. Financial institution system 150 may comprise one or more of a payment product engine 253, an application programming interface (API) 256, a software development kit (SDK) 258, and/or a financial institution blockchain node 260 configured to maintain marketplace blockchain 105. Payment product engine 253, API 256, SDK 258, and/or financial institution blockchain node 260 may be in direct logical communication with each other via a bus, network, and/or through any other suitable means, or may be individually connected as described further herein.

In various embodiments, payment product engine 253 may be configured to retrieve seller quotes from marketplace blockchain 105, via financial institution blockchain node 260, generate one or more financing products based on the seller quote, and transmit the financing products to marketplace blockchain 105, via financial institution blockchain node 260, as discussed further herein. In response to the buyer selecting and accepting a financing product and writing a financing product confirmation to marketplace blockchain 105, payment product engine 253 may be configured to transmit a payment based on the financing product to seller system 130, as discussed further herein. Payment product engine 253 may be in electronic and/or operative communication with back-end systems of financial institution system 150, such as, for example, authorization engines, authentication engines and databases, settlement engines and databases, accounts receivable systems and databases, accounts payable systems and databases, and/or the like. Payment product engine 253 may also be in electronic communication with financial institution blockchain node 260, via API 256 and/or SDK 258.

In various embodiments, API 256 and SDK 258 may be configured to provide software, services, and interfaces to enable communications between payment product engine 253 and financial institution blockchain node 260. API 256 and SDK 258 may comprise programmatic libraries configured to translate and transmit queries and commands from payment product engine 253 to financial institution blockchain node 260. For example, and in accordance with various embodiments, API 256 and/or SDK 258 may be configured to translate data received from payment product engine 253 into a blockchain format using a blockchain SDK library, or the like, which may include digital signing using financial institution-specific security certificates. In that respect, API 256 and/or SDK 258 may comprise one or more financial institution -specific cryptographic keys used to perform cryptographic operations. As a further example, and in accordance with various embodiments, API 256 and/or SDK 258 may be configured to translate data retrieved from marketplace blockchain 105 into a format readable by payment product engine 253, which may include digital signature verification and/or data transformation from a blockchain specific data layout to an application specific data layout.

As an example, SDK 258 may include a blockchain oracle configured to generate one or more notifications in response to data being written to marketplace blockchain 105. The blockchain oracle may be configured to query financial institution blockchain node 260 at a defined interval to search for new writes to marketplace blockchain 105. The blockchain oracle may be controlled by notification triggers containing filters indicating the types of data written to marketplace blockchain 105 that will generate a notification. For example, in response to the blockchain oracle determining that data has been written to marketplace blockchain 105 that includes the seller ID and data indicating a seller's response to a buying request (e.g., a seller quote was written to marketplace blockchain 105), the blockchain oracle may generate a seller quote notification and transmit the seller quote notification to payment product engine 253. As a further example, in response to the blockchain oracle determining that data has been written to marketplace blockchain 105 that includes the buyer ID, a financial institution ID, and data indicating a financing product was selected by the buyer (e.g., a financing product confirmation was written to marketplace blockchain 105), the blockchain oracle may generate a buyer financing notification and transmit the buyer financing notification to payment product engine 253.

In various embodiments, financial institution blockchain node 260 may be in electronic communication with blockchain network 101, and may be configured to allow financial institution system 150 access to marketplace blockchain 105 and blockchain network 101. Financial institution blockchain node 260 may be configured to maintain a copy of marketplace blockchain 105, write to and/or retrieve data and blocks from marketplace blockchain 105, validate blocks of marketplace blockchain 105, and/or propagate writes to marketplace blockchain 105 to blockchain network 101. Financial institution blockchain node 260 may communicate with one or more blockchain nodes (e.g., buyer blockchain node 220, seller blockchain node 240, etc.) to validate and write blocks to marketplace blockchain 105, and to establish consensus between the blockchain nodes based on proof of work, proof of stake, practical byzantine fault tolerance, delegated proof of stake, or other suitable consensus algorithms.

Financial institution blockchain node 260 may comprise one or more computing devices, such as, for example a computer or processor, or a set of computers, processor, and/or application specific integrated circuits (ASICs), although other types of computing units or system may also be used. Exemplary computing devices may include servers, pooled servers, laptops, notebooks, hand held computers, personal digital assistants, cellular phones, smart phones (e.g., IPHONE®, BLACKBERRY®, ANDROID®, etc.), tablets, wearables (e.g., smart watches, smart glasses, etc.), Internet of things (IoT) devices, or any other device capable of receiving data over a network. Financial institution blockchain node 260 may run applications to interact with marketplace blockchain 105, communicate with other devices, perform crypto operations, and otherwise operate within financial institution system 150. For example, financial institution blockchain node 260 may run a client application that can be a thin client (web), a hybrid (i.e., web and native, such as iOS and Android), or a native application to make application programming interface (API) calls to interact with marketplace blockchain 105, such as a web3 API compatible with blockchain databases maintained by ETHEREUM®.

With reference again to FIG. 1, a blockchain address may be uniquely assigned to each buyer system 110, seller system 130, and/or financial institution system 150 to function as a unique identifier in system 100. For example, each buyer system 110, seller system 130, and/or financial institution system 150 may register with system 100 and/or an existing trust participant (e.g., identity provider), and may be assigned and provided a private key and public key pair. For example, and in accordance with various embodiments, in a permissioned blockchain consortium, each individual participant system (buyer system 110, seller system 130, and/or financial institution system 150) will procure a public key and private key pair from a third-party certificate authority (like DigiCert®, VeriSign®, etc.). In a blockchain consortium, one of the participant systems (e.g., financial institution system 150) may initiate and create the blockchain network and may invite (or receive invitation requests from) one or more of the other participants to join the blockchain consortium. Invited participants may accept the request by transmitting a configuration request to join the blockchain consortium. The configuration request may be validated and/or approved by existing participants of the blockchain consortium using digital signature verification.

The private key may be stored with each respective buyer system 110, seller system 130, and/or financial institution system 150, and as discussed further herein, data can be encrypted with the public key prior to writing to marketplace blockchain 105. In response to retrieving the data from marketplace blockchain 105, the associated buyer system 110, seller system 130, and/or financial institution system 150 may decrypt the data using the private key. System 100 may generate the public key and private key pair using any suitable key pair generation technique and asymmetric key algorithm. In various embodiments, system 100 may use a Hierarchical Deterministic (HD) solution to enable the creation of one or more child keys from one or more parents keys in a hierarchy. Each child key may be assigned to an individual buyer system 110, seller system 130, and/or financial institution system 150. For example, system 100 may use BIP32, BIP39, and/or BIP44 to generate an HD tree of public addresses.

The various communications discussed herein may be performed using a network. As used herein, the term “network” may further include any cloud, cloud computing system or electronic communications system or method that incorporates hardware and/or software components. Communication among the parties may be accomplished through any suitable communication channels, such as, for example, a telephone network, an extranet, an intranet, Internet, point of interaction device (point of sale device, personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g., IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. Asymmetric encryption in particular may be of use in signing and verifying signatures for blockchain crypto operations.

Referring now to FIGS. 3-6, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 3-6, but also to the various system components as described above with reference to FIGS. 1, 2A, 2B, and 2C.

With specific reference to FIG. 3, a process 301 for initiating a buying request in the buyer-centric marketplace system is shown according to various embodiments. A buyer may interact with user terminal 212 to access buyer user interface 214. For example, the buyer may access buyer user interface 214 to register for access to system 100 and to receive a unique buyer ID, to transmit a buying request, to review seller quotes and/or financing products, and to complete transactions. As a further example, buyer user interface 214 may be hosted by one or more companies (e.g., seller system 130, financial institution system 150, etc.) connected to blockchain network 101 through a company-specific blockchain node. The buyer may interface with the company system to receive the buyer ID, input buyer information (e.g., shipping information, etc.), and/or the like. In various embodiments, buyer user interface 214 receives a buying request (step 302) from user terminal 212. The buying request may comprise a buyer ID, a buying category (e.g., a product or service), a buying sub-category (e.g., a chair, a couch, etc.), a buying criteria (e.g., product characteristics, dimensions etc.), a buying comment (e.g., buyer input of a specified request), and/or the like. In various embodiments, buyer user interface 214 may generate a unique transaction ID (e.g., a generated number) and append the transaction ID to the buying request.

In various embodiments, the buying request may be encrypted using any suitable type of encryption, such as, for example, a multi-party encryption hybrid cipher (e.g., GnuPG, etc.). A symmetric key may be generated and the buying request may be encrypted using the symmetric key. The symmetric key may be encrypted using the seller system 130 or financial institution system 150 public key, and the encrypted symmetric key may be appended to the encrypted buying request. In that regard, the public key of each entity may be shared across blockchain network 101 in response to an entity joining the blockchain network 101. The receiving party (e.g., the seller system 130 or financial institution system 150) may use the private key to decrypt the symmetric key, and may use the decrypted symmetric key to decrypt the encrypted buyer message.

Buyer user interface 214 transmits the buying request to buyer blockchain node 220 (step 304) via API 216 and SDK 218. In response to receiving the buying request, buyer blockchain node 220 writes the buying request to marketplace blockchain 105 (step 306). Buyer blockchain node 220 propagates the write to blockchain network 101 (step 308). Buyer blockchain node 220 may propagate the buying request by transmitting the buying request to at least a second blockchain node in blockchain network 101 for writing to marketplace blockchain 105.

With specific reference to FIG. 4, a process 401 for generating a seller quote based on the buying request in the buyer-centric marketplace system is shown according to various embodiments. In various embodiments, seller system 130 may be a participant in the blockchain consortium and may comprise a seller blockchain node 240 in electronic communication with blockchain network 101. Seller system 130 may generate a unique seller ID in response to joining the blockchain consortium, and may share the seller ID to participating entities. In various embodiments, seller system 130 may also be hosted by one or more companies (e.g., seller system 130, financial institution system 150, etc.) connected to blockchain network 101 through a company-specific blockchain node. Seller system 130 may interact with the company to receive a unique seller ID.

In various embodiments, fulfillment engine 233 receives a buying request notification (step 402) from SDK 238. The buying request notification may be generated in response to a blockchain oracle in SDK 238 determining that a buying request was written to marketplace blockchain 105. The buying request notification may comprise data corresponding to the buying request, such as, for example, a transaction link to the data record on marketplace blockchain 105, and/or the buyer ID associated with the buying request. Fulfillment engine 233 queries seller blockchain node 240 to retrieve the buying request from marketplace blockchain 105 (step 404), via API 236 and SDK 238.

Fulfillment engine 233 generates a seller quote based on the buying request (step 406). In various embodiments, the seller quote may be automatically generated. For example, fulfillment engine 233 may receive and validate the buying request and may retrieve a matching seller quote from a predefined product pricing database in fulfillment engine 233. For example, for a standard buyer request, product specification details may be requested to be selected by the buyer (e.g. for a TV buying request, attributes to be requested will be brand, screen size, screen resolution, etc.). The product specification details may be defined by marketplace applications and/or sellers, and may be communicated with each other through blockchain transactions. In various embodiments, fulfillment engine 233 may also be manually generated, through input from a seller user terminal or the like. The seller quote may comprise the seller ID, product information or service information, a quote price, and/or a quote fulfillment date. The product information may include data such as a product ID, a product description, product shipment or delivery options, or the like. The service information may include data such as a service description or ID, service fulfillment information, a service timeframe, or the like. The seller quote may also comprise the buyer ID. In various embodiments, the seller quote may also be generated to comprise the transaction ID. In various embodiments, the seller quote may be encrypted using any suitable type of encryption, such as, for example, a multi-party encryption hybrid cipher (e.g., GnuPG, etc.). A symmetric key may be generated and the seller quote may be encrypted using the symmetric key. The symmetric key may be encrypted using the buyer system 110 or financial institution system 150 public key, and the encrypted symmetric key may be appended to the encrypted seller quote. In that regard, the public key of each entity may be shared across blockchain network 101 in response to an entity joining the blockchain network 101. The receiving party (e.g., the buyer system 110 or financial institution system 150) may use the private key to decrypt the symmetric key, and may use the decrypted symmetric key to decrypt the encrypted seller quote.

Fulfillment engine 233 transmits the seller quote to seller blockchain node 240 (step 408) via API 236 and SDK 238. In response to receiving the seller quote, seller blockchain node 240 writes the seller quote to marketplace blockchain 105 (step 410). Seller blockchain node 240 propagates the write to blockchain network 101 (step 412). Seller blockchain node 240 may propagate the seller quote by transmitting the seller quote to at least a second blockchain node in blockchain network 101 for writing to marketplace blockchain 105.

With specific reference to FIG. 5, a process 501 for generating a financing product based on the seller quote in the buyer-centric marketplace system is shown according to various embodiments. In various embodiments, financial institution system 150 may be a participant in the blockchain consortium and may comprise a financial institution blockchain node 260 in electronic communication with blockchain network 101. Financial institution system 150 may generate a unique financial institution ID in response to joining the blockchain consortium, and may share the financial institution ID to participating entities.

In various embodiments, payment product engine 253 receives a seller quote notification (step 502) from SDK 258. The seller quote notification may be generated in response to a blockchain oracle in SDK 258 determining that a seller quote was written to marketplace blockchain 105. The seller quote notification may comprise data corresponding to the seller quote, such as, for example, a transaction link to the data record on marketplace blockchain 105, and/or the seller ID associated with the seller quote. Payment product engine 253 queries financial institution blockchain node 260 to retrieve the seller quote from marketplace blockchain 105 (step 504), via API 256 and SDK 258.

Payment product engine 253 generates a financing product based on the seller quote (step 506). In various embodiments, the financing product may be automatically generated, via payment product engine 253, based on the seller quote (e.g., for standard seller quotes). For example, payment product engine 253 may receive and validate the seller quote and retrieve a financing product from a predefined financing product database stored in payment product engine 253. In various embodiments, buyer data such as name, address, transaction account details, credit history, product cost, financing amount request, or the like may impact the financing product generated. In various embodiments, the financing product may also be manually generated, such as, for example, via a user terminal in electronic communication with payment product engine 253. The financing product may comprise a payment product, financing offer, or the like to enable the buyer to purchase product or service in the seller quote. The financing product may include a financial institution ID and the financing offer. For example, the financing offer may include an installment payment plan (e.g., monthly payments for 6 months), an installment financing plan (e.g., monthly payments for 6 months at 5% interest), a financing discount (e.g., 5% off the purchase price), or the like. The financing product may also comprise the buyer ID and/or the seller ID. In various embodiments, the financing product may also be generated to comprise the transaction ID.

In various embodiments, the financing product may be encrypted using any suitable type of encryption, such as, for example, a multi-party encryption hybrid cipher (e.g., GnuPG, etc.). A symmetric key may be generated and the financing product may be encrypted using the symmetric key. The symmetric key may be encrypted using the buyer system 110 or seller system 130 public key, and the encrypted symmetric key may be appended to the encrypted financing product. In that regard, the public key of each entity may be shared across blockchain network 101 in response to an entity joining the blockchain network 101. The receiving party (e.g., the buyer system 110 or seller system 130) may use the corresponding private key to decrypt the symmetric key, and may use the decrypted symmetric key to decrypt the encrypted financing product.

Payment product engine 253 transmits the financing product to financial institution blockchain node 260 (step 508) via API 256 and SDK 258. In response to receiving the financing product, financial institution blockchain node 260 writes the financing product to marketplace blockchain 105 (step 510). Financial institution blockchain node 260 propagates the write to blockchain network 101 (step 512). Financial institution blockchain node 260 may propagate the financing product by transmitting the financing product to at least a second blockchain node in blockchain network 101 for writing to marketplace blockchain 105.

With specific reference to FIG. 6, a process 601 for completing a buyer order in the buyer-centric marketplace system is shown according to various embodiments. Buyer user interface 214 receives a seller quote notification (step 602) from SDK 218. The seller quote notification may be generated in response to a blockchain oracle in SDK 218 determining that a seller quote was written to marketplace blockchain 105. The seller quote notification may comprise data corresponding to the seller quote, such as, for example, a transaction link to the data record on marketplace blockchain 105, and/or the buyer ID, seller ID, and/or transaction ID associated with the seller quote. Buyer user interface 214 queries buyer blockchain node 220 to retrieve the seller quote from marketplace blockchain 105 (step 604), via API 216 and SDK 218.

Buyer user interface 214 receives a financing product notification (step 606) from SDK 218. The financing product notification may be generated in response to a blockchain oracle in SDK 218 determining that a financing product was written to marketplace blockchain 105. The financing product notification may comprise data corresponding to the financing product, such as, for example, a transaction link to the data record on marketplace blockchain 105, and/or the buyer ID, seller ID, financial institution ID, and/or transaction ID associated with the financing product. Buyer user interface 214 queries buyer blockchain node 220 to retrieve the financing product from marketplace blockchain 105 (step 608), via API 216 and SDK 218.

Buyer user interface 214 generates a buyer order based on the seller quote (step 610). For example, a buyer, via user terminal 212, may view one or more seller quotes to determine the desired seller quote to proceed with purchasing. The generated buyer order may comprise data indicating the buyer's acceptance of the seller quote. For example, the buyer order may comprise the buyer ID, the seller ID, buyer identifying data (e.g., shipment address, etc.), a purchase confirmation, and the like. In various embodiments, the buyer order may also comprise the transaction ID.

Buyer user interface 214 generates a financing product confirmation (step 612). For example, the buyer, via user terminal 212, may view one or more financing products to determine the desired financing product to proceed with using to purchase the seller quote. The generated financing product confirmation may comprise data indicating the buyer's acceptance of the financing product. In various embodiments, the buyer may also select to proceed with purchasing the seller quote without using a financing product. For example, wherein the buyer has a transaction account with financial institution system 150, the financing product confirmation may then comprise data indicating that the buyer desires to proceed with the purchase by using the transaction account. The financing product confirmation may comprise the buyer ID, the seller ID, the financial institution ID, a financing product acceptance, and the like. In various embodiments, the financing product confirmation may also comprise the transaction ID.

Buyer user interface 214 transmits the buyer order and/or the financing product confirmation to buyer blockchain node 220 (step 614), via API 216 and SDK 218. In response to receiving the buyer order, buyer blockchain node 220 writes the buyer order to marketplace blockchain 105 and propagates the write to blockchain network 101 (step 616). Buyer blockchain node 220 may propagate the buyer order by transmitting the buyer order to at least a second blockchain node in blockchain network 101 for writing to marketplace blockchain 105. In response to receiving the financing product confirmation, buyer blockchain node 220 writes the financing product confirmation to marketplace blockchain 105 and propagates the write to blockchain network 101 (step 618). Buyer blockchain node 220 may propagate the financing product confirmation by transmitting the financing product confirmation to at least a second blockchain node in blockchain network 101 for writing to marketplace blockchain 105.

In various embodiments, fulfillment engine 233 receives a buyer order notification and retrieves the buyer order from marketplace blockchain 105 (step 620) by querying seller blockchain node 240. The buyer order notification may be generated in response to a blockchain oracle in SDK 238 determining that a buyer order was written to marketplace blockchain 105. The buyer order notification may comprise data corresponding to the buyer order, such as, for example, a transaction link to the data record on marketplace blockchain 105, and/or the buyer ID and/or transaction ID associated with the buyer order. In various embodiments, in response to retrieving the buyer order, fulfillment engine 233 may begin to process the buyer order and to pend the status of the buyer order until payment is received.

In various embodiments, payment product engine 253 receives a buyer financing notification and retrieves the financing product confirmation from marketplace blockchain 105 (step 622) by querying financial institution blockchain node 260. The buyer financing notification may be generated in response to a blockchain oracle in SDK 238 determining that a financing product confirmation was written to marketplace blockchain 105. The buyer financing notification may comprise data corresponding to the financing product confirmation, such as, for example, a transaction link to the data record on marketplace blockchain 105, and/or the buyer ID and/or transaction ID associated with the financing product confirmation. In various embodiments, in response to retrieving the financing product confirmation, payment product engine 253 may begin processing the data and generating a payment to complete the buyer order. Payment product engine 253 transmits a payment to fulfillment engine 233 (step 624). The payment may comprise the buyer ID, the seller ID, the financial institution ID, the transaction ID, and/or payment information.

In various embodiments, in response to receiving the payment, fulfillment engine 233 completes the buyer order (step 626). For example, fulfillment engine 233 may process and settle the payment. In response to the buyer order comprising a physical product, fulfillment engine 233 may instruct back-end systems in seller system 130 to complete the purchase and ship the product. In response to the buyer order comprising a digital product, fulfillment engine 233 may instruct back-end systems in seller system 130 to complete the purchase and transmit the digital product (or a link to the digital product) to user terminal 212. In response to the buyer order comprising a service, fulfillment engine 233 may instruct back-end systems in seller system 130 to complete the purchase and schedule the service with the buyer.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward points, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The computer system (e.g., user terminal 212) or any components may integrate with system integration technology such as, for example, the ALEXA system developed by AMAZON®. ALEXA is a cloud-based voice service that can help you with tasks, entertainment, general information and more. All AMAZON® ALEXA devices, such as the AMAZON ECHO®, AMAZON ECHO DOT®, AMAZON TAP®, and AMAZON FIRE® TV, have access to the ALEXA system. The ALEXA system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The ALEXA system may allow the user to access information about eligible accounts linked to an online account across all ALEXA-enabled devices.

The phrases consumer, customer, user, account holder, account affiliate, cardmember or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Any communication, transmission and/or channel discussed herein may include any system or method for delivering content (e.g. data, information, metadata, etc.), and/or the content itself The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, a FACEBOOK® message, a TWITTER® tweet, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, and in accordance with various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, JBOSS EDB® POSTGRES PLUS ADVANCED SERVER® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers

Any databases discussed herein may include relational, hierarchical, graphical, blockchain, or object-oriented structure and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MySQL by MySQL AB (Uppsala, Sweden), MONGODB®, REDIS®, APACHE CASSANDRA®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (e.g., 10.0.0.2). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 3-5, the process flows and screenshots depicted are merely embodiments and are not intended to limit the scope of the disclosure. For example, the steps recited in any of the method or process descriptions may be executed in any order and are not limited to the order presented.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of enabling a buyer-centric marketplace using blockchain, but the disclosure and claims include specific rules for implementing the outcome of a buyer-centric marketplace using blockchain and that render information into a specific format that is then used and applied to create the desired results of enabling a buyer-centric marketplace using blockchain, as set forth in McRO, Inc. v. Bandai Namco Games America Inc. (Fed. Cir. case number 15-1080, Sep. 13, 2016). In other words, the outcome of enabling a buyer-centric marketplace using blockchain can be performed by many different types of rules and combinations of rules, and this disclosure includes various embodiments with specific rules. While the absence of complete preemption may not guarantee that a claim is eligible, the disclosure does not sufficiently preempt the field of buyer-centric marketplaces at all. The disclosure acts to narrow, confine, and otherwise tie down the disclosure so as not to cover the general abstract idea of just a buyer-centric marketplace. Significantly, other systems and methods exist for enabling buyer-centric marketplaces, so it would be inappropriate to assert that the claimed invention preempts the field or monopolizes the basic tools of buyer-centric marketplaces. In other words, the disclosure will not prevent others from enabling buyer-centric marketplaces, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the systems and methods may include a graphical user interface for dynamically relocating/rescaling obscured textual information of an underlying window to become automatically viewable to the user (e.g., via user terminal 212). By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., buying requests, seller quotes, financing products, buyer orders, financing product confirmations, payments, etc.) to prevent a computer or network from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
writing, by a buyer blockchain node to a marketplace blockchain, a buying request comprising a buyer ID, a buying category, and a buying criteria;
retrieving, by the buyer blockchain node from the marketplace blockchain, a seller quote, wherein the seller quote is written to the marketplace blockchain by a seller blockchain node, and wherein the seller quote is based on the buying request and comprises a seller ID, the buyer ID, a quote price, and at least one of product information or service information;
retrieving, by the buyer blockchain node from the marketplace blockchain, a financing product, wherein the financing product is written to the marketplace blockchain by a financial institution blockchain node, and wherein the financing product is based on the seller quote and comprises a financial institution ID, the seller ID, the buyer ID, and a financing offer;
writing, by the buyer blockchain node to the marketplace blockchain, a buyer order, wherein the buyer order is based on the seller quote, and wherein the buyer order comprises the buyer ID, the seller ID, buyer identifying data, and a purchase confirmation; and
writing, by the buyer blockchain node to the marketplace blockchain, a financing product confirmation, wherein the financing product confirmation is based on the financing product, and wherein the financing product confirmation comprises the buyer ID, the seller ID, the financial institution ID, and a financing product acceptance.

2. The method of claim 1, wherein in response to the buyer blockchain node writing the financing product confirmation to the marketplace blockchain, the financial institution blockchain node is configured to retrieve the financing product confirmation from the marketplace blockchain, and wherein a financial institution system associated with the financial institution blockchain node is configured to transmit a payment to a seller system associated with the seller blockchain node.

3. The method of claim 2, wherein in response to the buyer blockchain node writing the buyer order to the marketplace blockchain and in response to receiving the payment from the financial institution system, the seller system is configured to retrieve the buyer order from the marketplace blockchain and complete the buyer order.

4. The method of claim 1, wherein the seller quote is written to the marketplace blockchain in response to the seller blockchain node receiving a buying request notification from a seller blockchain oracle, retrieving the buying request from the marketplace blockchain, and receiving the seller quote from the seller system.

5. The method of claim 1, wherein the financing product is written to the marketplace blockchain in response to the financial institution blockchain node receiving a seller quote notification from a financial institution blockchain oracle, retrieving the seller quote from the marketplace blockchain, and receiving the financing product from the financial institution system.

6. The method of claim 1, wherein the buyer order is written to the marketplace blockchain in response to the buyer blockchain node receiving a second seller quote notification from a buyer blockchain oracle, retrieving the seller quote from the marketplace blockchain, and receiving the buyer order from a buyer system associated with the buyer blockchain node, and
wherein the financing product confirmation is written to the marketplace blockchain in response to the buyer blockchain node receiving a financing product notification from the buyer blockchain oracle, retrieving the financing product from the marketplace blockchain, and receiving the financing product confirmation from the buyer system.

7. The method of claim 1, wherein the buying request, the seller quote, the financing product, the buyer order, the financing product confirmation, and the payment each comprise a transaction ID.

8. A computer-based system, comprising:
a processor; and
a tangible, non-transitory memory configured to communicate with the processor, the tangible, non-transitory memory having instructions stored thereon that, in response to execution by the processor, cause a buyer blockchain node to perform operations comprising:
writing, by the buyer blockchain node to a marketplace blockchain, a buying request comprising a buyer ID, a buying category, and a buying criteria;
retrieving, by the buyer blockchain node from the marketplace blockchain, a seller quote, wherein the seller quote is written to the marketplace blockchain by a seller blockchain node, and wherein the seller quote is based on the buying request and comprises a seller ID, the buyer ID, a quote price, and at least one of product information or service information;
retrieving, by the buyer blockchain node from the marketplace blockchain, a financing product, wherein the financing product is written to the marketplace blockchain by a financial institution blockchain node, and wherein the financing product is based on the seller quote and comprises a financial institution ID, the seller ID, the buyer ID, and a financing offer;
writing, by the buyer blockchain node to the marketplace blockchain, a buyer order, wherein the buyer order is based on the seller quote, and wherein the buyer order comprises the buyer ID, the seller ID, buyer identifying data, and a purchase confirmation; and
writing, by the buyer blockchain node to the marketplace blockchain, a financing product confirmation, wherein the financing product confirmation is based on the financing product, and wherein the financing product confirmation comprises the buyer ID, the seller ID, the financial institution ID, and a financing product acceptance.

9. The system of claim 8, wherein in response to the buyer blockchain node writing the financing product confirmation to the marketplace blockchain, the financial institution blockchain node is configured to retrieve the financing product confirmation from the marketplace blockchain, and wherein a financial institution system associated with the financial institution blockchain node is configured to transmit a payment to a seller system associated with the seller blockchain node.

10. The system of claim 9, wherein in response to the buyer blockchain node writing the buyer order to the marketplace blockchain and in response to receiving the payment from the financial institution system, the seller system is configured to retrieve the buyer order from the marketplace blockchain and complete the buyer order.

11. The system of claim 8, wherein the seller quote is written to the marketplace blockchain in response to the seller blockchain node receiving a buying request notification from a seller blockchain oracle, retrieving the buying request from the marketplace blockchain, and receiving the seller quote from the seller system.

12. The system of claim 8, wherein the financing product is written to the marketplace blockchain in response to the financial institution blockchain node receiving a seller quote notification from a financial institution blockchain oracle, retrieving the seller quote from the marketplace blockchain, and receiving the financing product from the financial institution system.

13. The system of claim 8, wherein the buyer order is written to the marketplace blockchain in response to the buyer blockchain node receiving a second seller quote notification from a buyer blockchain oracle, retrieving the seller quote from the marketplace blockchain, and receiving the buyer order from a buyer system associated with the buyer blockchain node, and
wherein the financing product confirmation is written to the marketplace blockchain in response to the buyer blockchain node receiving a financing product notification from the buyer blockchain oracle, retrieving the financing product from the marketplace blockchain, and receiving the financing product confirmation from the buyer system.

14. The system of claim 8, wherein the buying request, the seller quote, the financing product, the buyer order, the financing product confirmation, and the payment each comprise a transaction ID.

15. An article of manufacture including a non-transitory, tangible computer readable storage medium having instructions stored thereon that, in response to execution by a buyer blockchain node, cause the buyer blockchain node to perform operations comprising:
writing, by the buyer blockchain node to a marketplace blockchain, a buying request comprising a buyer ID, a buying category, and a buying criteria;
retrieving, by the buyer blockchain node from the marketplace blockchain, a seller quote, wherein the seller quote is written to the marketplace blockchain by a seller blockchain node, and wherein the seller quote is based on the buying request and comprises a seller ID, the buyer ID, a quote price, and at least one of product information or service information;
retrieving, by the buyer blockchain node from the marketplace blockchain, a financing product, wherein the financing product is written to the marketplace blockchain by a financial institution blockchain node, and wherein the financing product is based on the seller quote and comprises a financial institution ID, the seller ID, the buyer ID, and a financing offer;
writing, by the buyer blockchain node to the marketplace blockchain, a buyer order, wherein the buyer order is based on the seller quote, and wherein the buyer order comprises the buyer ID, the seller ID, buyer identifying data, and a purchase confirmation; and
writing, by the buyer blockchain node to the marketplace blockchain, a financing product confirmation, wherein the financing product confirmation is based on the financing product, and wherein the financing product confirmation comprises the buyer ID, the seller ID, the financial institution ID, and a financing product acceptance.

16. The article of manufacture of claim 15, wherein in response to the buyer blockchain node writing the financing product confirmation to the marketplace blockchain, the financial institution blockchain node is configured to retrieve the financing product confirmation from the marketplace blockchain, and wherein a financial institution system associated with the financial institution blockchain node is configured to transmit a payment to a seller system associated with the seller blockchain node.

17. The article of manufacture of claim 16, wherein in response to the buyer blockchain node writing the buyer order to the marketplace blockchain and in response to receiving the payment from the financial institution system, the seller system is configured to retrieve the buyer order from the marketplace blockchain and complete the buyer order.

18. The article of manufacture of claim 15, wherein the seller quote is written to the marketplace blockchain in response to the seller blockchain node receiving a buying request notification from a seller blockchain oracle, retrieving the buying request from the marketplace blockchain, and receiving the seller quote from the seller system.

19. The article of manufacture of claim 15, wherein the financing product is written to the marketplace blockchain in response to the financial institution blockchain node receiving a seller quote notification from a financial institution blockchain oracle, retrieving the seller quote from the marketplace blockchain, and receiving the financing product from the financial institution system.

20. The article of manufacture of claim 15, wherein the buyer order is written to the marketplace blockchain in response to the buyer blockchain node receiving a second seller quote notification from a buyer blockchain oracle, retrieving the seller quote from the marketplace blockchain, and receiving the buyer order from a buyer system associated with the buyer blockchain node, and
wherein the financing product confirmation is written to the marketplace blockchain in response to the buyer blockchain node receiving a financing product notification from the buyer blockchain oracle, retrieving the financing product from the marketplace blockchain, and receiving the financing product confirmation from the buyer system.
